(19) United States
(12) Patent Application Publication
(10) Pub. No.: US 2025/0101044 A1
(43) Pub. Date: Mar. 27, 2025

(54) METAL-ORGANIC FRAMEWORK COMPOSITE AND PREPARATION METHOD AND USE THEREOF

(71) Applicant: ZHEJIANG UNIVERSITY, Hangzhou (CN)

(72) Inventors: Tian DING, Hangzhou (CN); Mofei SHEN, Hangzhou (CN); Jianwei ZHOU, Hangzhou (CN); Jinsong FENG, Hangzhou (CN); Donghong LIU, Hangzhou (CN); Enbo XU, Hangzhou (CN); Wenjun WANG, Hangzhou (CN); Huan CHENG, Hangzhou (CN); Shiguo CHEN, Hangzhou (CN)

(73) Assignee: ZHEJIANG UNIVERSITY, Hangzhou (CN)

(21) Appl. No.: 18/020,637

(22) PCT Filed: Mar. 11, 2022
(86) PCT No.: PCT/CN2022/080303

§ 371 Date: May 23, 2024

(30) Foreign Application Priority Data
Nov. 10, 2021 (CN) 202111328160.5

(51) Int. Cl. C07F 1/10; B82Y 40/00; C07F 1/06

(52) U.S. Cl. CPC C07F 1/10; B82Y 40/00; C07F 1/06

(57) ABSTRACT

Disclosed are a metal-organic framework composite and a preparation method and use thereof. The metal-organic framework composite includes a cyclodextrin metal-organic framework (CD-MOF) material, and nano-silver and caffeic acid that are loaded in the CD-MOF material; wherein the nano-silver is loaded at 4% to 5% of a total mass of the composite; and caffeic acid is loaded at 11% to 12% of the total mass of the composite. The method for preparing the metal-organic framework composite includes: placing a CD-MOF material in an ethanol solution containing silver nitrate to obtain a first mixture, and subjecting the first mixture to a dynamic contact reaction in the dark to obtain a CD-MOF loaded with nano-silver; and placing the CD-MOF loaded with nano-silver in an ethanol solution containing caffeic acid to obtain a second mixture, and subjecting the second mixture to an incubation in the dark to obtain the composite.

### CROSS REFERENCE TO RELATED APPLICATION

The present application claims priority of Chinese Patent Application No. 202111328160.5, filed with the China National Intellectual Property Administration (CNIPA) on Nov. 10, 2021, and entitled “METAL-ORGANIC FRAMEWORK COMPOSITE AND PREPARATION METHOD AND USE THEREOF”, which is incorporated herein by reference in its entirety.

### TECHNICAL FIELD

The present disclosure relates to the technical field of antibacterial materials, in particular to a metal-organic framework (MOF) composite and a preparation method and use thereof.

### BACKGROUND

Metal-organic frameworks (MOFs), as porous coordination materials composed of multidentate organic ligands and metal ions or metal clusters, are infinite network structures formed by coordination bond or covalent bond between the center of the metal ion and the organic ligand. The MOF is a rapidly-developing novel porous material with broad prospects for use due to large specific surface area, tunable functions, and high porosity.

Cyclodextrins are naturally occurring cyclic oligosaccharides that are produced by cyclodextrin glycosyltransferase during the enzymatic degradation of starch. Cyclodextrins generally contain 6 to 12 D-glucopyranose units, among which molecules with 6, 7, and 8 D-glucopyranose units are of great practical significance, called α-, β-, and γ-cyclodextrins, respectively. Cyclodextrin metal-organic framework (CD-MOF) is a new MOF formed by cyclodextrin and alkali metal ions through organic coordination. Compared with traditional MOFs, CD-MOF has desirable water solubility and non-toxicity, and has porosity and large specific surface area, and can play a protective role due to a huge cavity inside. Currently, the CD-MOF has become a research hotspot as a delivery material. However, the CD-MOF has a limited antibacterial effect when being used as a carrier to load antibacterial agents alone.

### SUMMARY

The present disclosure provides a MOF composite and a preparation method and use thereof. In the present disclosure, a CD-MOF material is used as a carrier, and loaded with nano-silver and caffeic acid simultaneously. The preparation method is simple, and the composite has a desirable antibacterial effect.

Compared with composites in the antibacterial field loaded with natural antibacterial agents alone, the composite in the present disclosure loaded with natural organic antibacterial agents and inorganic nanoparticles simultaneously makes it possible to improve an antibacterial effect of the composite. As a template, the CD-MOF is used to fixate nano-silver in a large internal cavity, preventing the aggregation of nano-silver, thereby maintaining a desirable antibacterial effect. Meanwhile, caffeic acid with poor stability is further loaded in remaining cavities inside the CD-MOF. Compared with a single-loaded CD-MOF, the CD-MOF of the present disclosure makes it possible to improve a utilization rate as a carrier, and improve the antibacterial effect of the composites by dual delivery of nano-silver and caffeic acid.

The present disclosure provides a MOF composite, including a CD-MOF material, and nano-silver and caffeic acid that are loaded in the CD-MOF material; where the CD-MOF material is prepared from γ-cyclodextrin; nano-silver is loaded at a mass content of 4% to 5% of a total mass of the composite; and caffeic acid is loaded at a mass content of 11% to 12% of the total mass of the composite.

Also provided is a method for preparing a MOF composite, including the following steps:
(1) placing a CD-MOF material prepared from γ-cyclodextrin in an ethanol solution containing silver nitrate to obtain a first mixture, and subjecting the first mixture to a dynamic contact reaction in the dark to obtain a CD-MOF loaded with nano-silver; and
(2) placing the CD-MOF loaded with nano-silver in an ethanol solution containing caffeic acid to obtain a second mixture, and subjecting the second mixture to an incubation in the dark to obtain a CD-MOF loaded with caffeic acid and nano-silver.

In the method of the present disclosure, nano-silver is loaded first by utilization of hydroxide ions in a large cavity of the CD-MOF. If caffeic acid is loaded first, caffeic acid may replace hydroxide ions, causing nano-silver to fail to load. Nano-silver loaded first may occupy a part of the large cavity of the CD-MOF, thereby affecting the loading of a part of caffeic acid. However, the loaded nano-silver and caffeic acid have a synergistic antibacterial effect. Even if the amount of caffeic acid loaded decreases, the antibacterial effect of the composite increases.

In some embodiments, in step (1), the ethanol solution containing silver nitrate has a concentration of silver nitrate of 0.5 mM to 10 mM; and a ratio of the mass of the CD-MOF material to the molar of silver nitrate is in the range of 100 mg:(0.0025-0.05) mmol.

In some embodiments, the ethanol solution containing silver nitrate has a concentration of silver nitrate of 2.5 mM to 7.5 mM; and a ratio of the mass of the CD-MOF material to the molar of silver nitrate is in the range of 100 mg:(0.0125-0.0375) mmol.

In some embodiments, the ethanol solution containing silver nitrate has a concentration of silver nitrate of 5 mM to 7.5 mM; and a ratio of the mass of the CD-MOF material to the molar of silver nitrate is in the range of 100 mg:(0.025-0.0375) mmol.

In some embodiments, the ethanol solution containing silver nitrate has a concentration of silver nitrate of 7.5 mM; and a ratio of the mass of the CD-MOF material to the molar of silver nitrate is 100 mg:0.0375 mmol.

In some embodiments, in step (1), the dynamic contact reaction is conducted for 1 hour to 18 hours. In some embodiments, in step (1), the dynamic contact reaction is conducted for 9 hours to 18 hours.

In some embodiments, in step (1), the ethanol solution containing silver nitrate has a concentration of silver nitrate of 5 mM to 7.5 mM; and a ratio of the mass of the CD-MOF material to the molar of silver nitrate is in the range of 100 mg:(0.025-0.0375) mmol; and the dynamic contact reaction is conducted for 10 hours to 15 hours.

In some embodiments, in step (1), the ethanol solution containing silver nitrate has a concentration of silver nitrate of 7.5 mM; and a ratio of the mass of the CD-MOF material to the molar of silver nitrate is 100 mg:0.0375 mmol; and the dynamic contact reaction is conducted for 12 hours.

In some embodiments, in step (2), a molar ratio of γ-cyclodextrin in the CD-MOF loaded with nano-silver to caffeic acid is in the range of 1:(25-70).

In some embodiments, in step (2), the incubation is conducted for 500 minutes to 1,000 minutes.

In some embodiments, in step (2), a molar ratio of γ-cyclodextrin in the CD-MOF loaded with nano-silver to caffeic acid is in the range of 1:(60-70); and the incubation is conducted at a temperature of 35° C. to 45° C. for 850 minutes to 950 minutes.

In some embodiments, a molar ratio of γ-cyclodextrin in the CD-MOF loaded with nano-silver to caffeic acid is 1:64; and the incubation is conducted at a temperature of 40° C. for 900 minutes.

In some embodiments, the CD-MOF material is prepared by a process, including the following steps:
subjecting an aqueous solution containing γ-cyclodextrin and potassium hydroxide to a first ultrasonic mixing to obtain a mixed solution; subjecting the mixed solution to a reaction in a water bath to obtain a reaction solution; subjecting the reaction solution to a second ultrasonic mixing while adding polyethylene glycol into the reaction solution to obtain a crude product; and subjecting the crude product to a washing and a drying, to obtain the CD-MOF material.

In some embodiments, in the aqueous solution containing γ-cyclodextrin and potassium hydroxide, a molar ratio of γ-cyclodextrin to potassium hydroxide is in the range of 1:(5-10). Generally, potassium ions in the CD-MOF material are in a form of 8-coordination, such that the potassium ions combine with six γ-cyclodextrin molecules to form a minimum building unit of the CD-MOF, which is equivalent to two potassium ions paired with one γ-cyclodextrin molecule, with a chemical formula of [(C₄₈H₈₀O₄₀)(KOH)₂]ₙ. In addition, excess potassium hydroxide is conducive to the participation of all γ-cyclodextrins in the reaction.

In some embodiments, polyethylene glycol has a molecular weight of 8,000, and a molar ratio of polyethylene glycol to γ-cyclodextrin is in the range of (0.06-0.07):1.

In some embodiments, the reaction in the water bath is conducted at a temperature of 55° C. to 65° C.

In some embodiments, the method further comprises a post-treatment after the dynamic contact reaction and the incubation in step (1) and step (2), and the post-treatment is performed by subjecting the reactant of the dynamic contact reaction and the reactant of the incubation to a centrifugation respectively, discarding a supernatant, and conducting a vacuum drying on a remaining product of centrifugation.

In some embodiments, the vacuum drying is conducted at a temperature of 40° C. to 60° C. for 4 hours to 6 hours.

Also provided is a MOF composite prepared by the method as described above.

Also provided is use of the MOF composite in preparation of an antibacterial product.

In some embodiments, the antibacterial product is an antibacterial film.

Compared with the prior art, the present disclosure has the following beneficial effects.
(1) In the present disclosure, the method by simultaneously loading nano-silver and caffeic acid with the CD-MOF material has a simple operation and a mild reaction. The CD-MOF loaded with nano-silver is prepared by an oscillation treatment for the first time, and the CD-MOF loaded with nano-silver and caffeic acid is prepared for the first time.
(2) In the present disclosure, the CD-MOF loaded with nano-silver and caffeic acid prepared by the method as described above has a relatively-uniform particle size, obvious X-ray diffraction (XRD) peaks, and desirable crystal characteristics, and has excellent thermal stability and chemical stability, which could be applied to researches in the fields of food and environment.
(3) Nano-silver and caffeic acid are loaded simultaneously, and cooperate with each other to jointly improve the antibacterial effect.

### BRIEF DESCRIPTION OF THE DRAWINGS

FIG. 1 is a diagram showing an influence result of a concentration of silver nitrate on a silver loading rate in the composite according to an embodiment.

FIG. 2 is a diagram showing an influence result of an incubation time of silver nitrate on a silver loading rate in the composite according to an embodiment.

FIG. 3 is a diagram showing a UV spectrum of a CD-MOF loaded with nano-silver prepared under different concentrations of silver nitrate according to embodiments after being dissolved in water.

FIG. 4 is a diagram showing an influence of a molar ratio of γ-cyclodextrin in the CD-MOF loaded with nano-silver to caffeic acid on a caffeic acid loading rate according to an embodiment.

FIG. 5 is a diagram showing an influence of an incubation time of caffeic acid and the CD-MOF loaded with nano-silver on a caffeic acid loading rate according to an embodiment.

FIG. 6 is a diagram showing a UV spectrum of a CD-MOF loaded with caffeic acid and nano-silver as prepared in Example 1 after being dissolved in water.

FIG. 7 is a diagram showing a scanning electron micrograph (SEM) image of a CD-MOF loaded with caffeic acid and nano-silver as prepared in Example 1.

FIG. 8 is a diagram showing an energy spectrum of a CD-MOF loaded with caffeic acid and nano-silver as prepared in Example 1.

FIG. 9 is a diagram showing a transmission electron micrograph (TEM) image of a CD-MOF loaded with caffeic acid and nano-silver as prepared in Example 1.

FIG. 10 is a diagram showing an infrared spectrogram of a CD-MOF loaded with caffeic acid and nano-silver as prepared in Example 1.

FIG. 11 is a diagram showing a powder X-ray diffraction (XRD) pattern of a CD-MOF loaded with caffeic acid and nano-silver as prepared in Example 1.

FIG. 12 is a diagram showing a nitrogen uptake isotherm of a CD-MOF loaded with caffeic acid and nano-silver as prepared in Example 1.

FIG. 13 is a diagram showing a thermogravimetric curve of a CD-MOF loaded with caffeic acid and nano-silver as prepared in Example 1.

### DETAILED DESCRIPTION OF THE EMBODIMENTS

The technical solutions of the present disclosure will be clearly and completely described as follows with reference to accompanying drawings. Apparently, the described embodiments are merely some rather than all of the embodiments of the present disclosure. All other embodiments obtained by those skilled in the art based on the embodiments of the present disclosure without creative efforts should fall within the protection scope of the present disclosure.

Unless otherwise defined, all technical and scientific terms used herein have the same meaning as commonly understood by those skilled in the art. The terms used in the specification of the present disclosure are merely for the purpose of describing specific embodiments, rather than to limit the present disclosure.

Caffeic acid is an organic acid found in many foods. In addition to food, caffeic acid also exists in common health medicines such as propolis, showing desirable antioxidant, antibacterial and other biological effects. However, the poor chemical and physical stability of caffeic acid and its derivatives limit their applications. Nano-silver is a special form of metallic silver, which has an excellent antibacterial ability. At present, there is no research on the simultaneous loading of two antibacterial substances using the CD-MOF material. There is an urgent need in the field to develop materials and methods that could simultaneously load the two antibacterial substances.

Based on this, the present disclosure proposes a CD-MOF composite capable of simultaneously loading caffeic acid and nano-silver and a preparation method thereof.

The CD-MOF composite includes a CD-MOF material, and nano-silver and caffeic acid loaded on the CD-MOF material; where the CD-MOF material is prepared from γ-cyclodextrin; the nano-silver is generated in a large cavity inside the CD-MOF material, and caffeic acid is filled in remaining cavities of the CD-MOF material.

In some embodiments, nano-silver is loaded at a mass content of 4% to 5% of a total mass of the composite; and caffeic acid is loaded at a mass content of 11% to 12% of the total mass of the composite.

Also provided is a method for preparing the MOF composite, including the following steps:
(1) placing a CD-MOF material in an ethanol solution containing silver nitrate to obtain a first mixture, and subjecting the first mixture to a dynamic contact reaction by an oscillation treatment in the dark to obtain a CD-MOF loaded with nano-silver (called as composite 1); and
(2) placing the CD-MOF loaded with nano-silver in an ethanol solution containing caffeic acid to obtain a second mixture, and subjecting the second mixture to an incubation by stirring in the dark to obtain the CD-MOF composite simultaneously loaded with caffeic acid and nano-silver (called as composite 2).

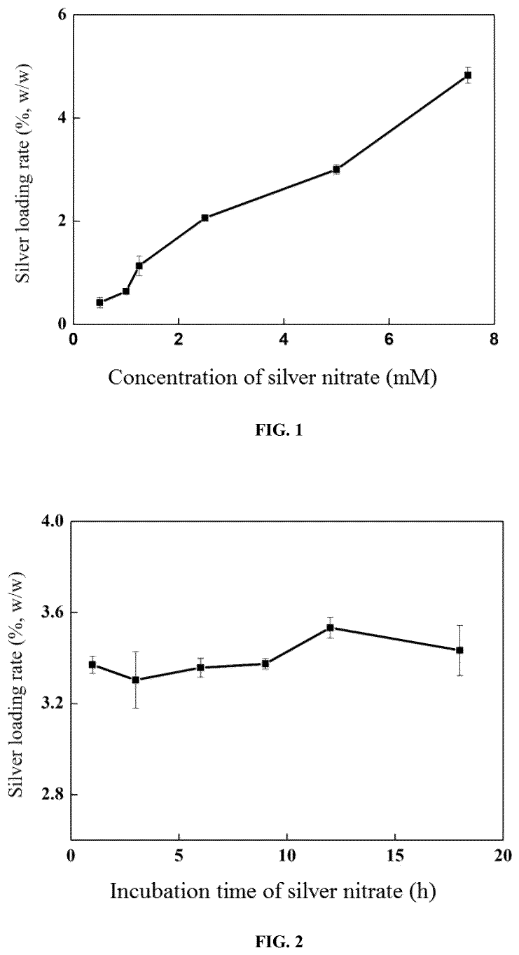

In some embodiments, in preparing the composite 1, under the conditions of fixing an amount of CD-MOF material and a reaction time of 12 h, the influence of different concentrations of silver nitrate (0.5 mM, 1 mM, 1.25 mM, 2.5 mM, 5 mM, 7.5 mM, and 10 mM) on the nano-silver loading rate is compared, and the results are shown in FIG. 1. From FIG. 1, it can be seen that, it is preferable that the ethanol solution containing silver nitrate has a concentration of silver nitrate of 2.5 mM to 7.5 mM, and a ratio of the mass of the CD-MOF material to the molar of silver nitrate is in the range of 100 mg:(0.0125-0.0375) mmol; it is more preferable that, the ethanol solution containing silver nitrate has a concentration of silver nitrate of 5 mM to 7.5 mM, and a ratio of the mass of the CD-MOF material to the molar of silver nitrate is in the range of 100 mg:(0.025-0.0375) mmol.

In some embodiments, in preparing the composite 1, under the conditions that the concentration of silver nitrate is fixed at 7.5 mM, and a ratio of the mass of the CD-MOF material to the molar of silver nitrate is fixed at 100 mg:0.0375 mmol, the influence of different reaction time of the CD-MOF material with silver nitrate (1 h, 3 hours, 6 hours, 9 hours, 12 hours, and 18 hours) on the nano-silver loading rate is compared, and the results are shown in FIG. 2. From FIG. 2, it can be seen that, with the prolongation of the reaction time, the loading rate first increases gradually, and then begins to decrease after reaching a critical point. It is preferable that the reaction time is 9 hours to 18 hours, and more preferably 10 hours to 15 hours.

Under comprehensive consideration, the composite 1 is prepared under the following optimal conditions: the ethanol solution containing silver nitrate has a concentration of silver nitrate of 7.5 mM; a ratio of the mass of the CD-MOF material to the molar of silver nitrate is 100 mg:0.0375 mmol; and the reaction is conducted for 12 hours.

In some embodiments, in preparing the composite 2, the experiment is conducted by utilization of the composite 1 prepared under optimal conditions, and the influence of different ratios of the composite 1 to caffeic acid (a molar ratio of γ-cyclodextrin in the composite 1 to caffeic acid is 1:8; 1:16, 1:32, 1:64, and 1:128, respectively) on the caffeic acid loading rate is compared. The results are shown in FIG. 4. From FIG. 4, it can be seen that, it is preferable that a molar ratio of γ-cyclodextrin to caffeic acid is in the range of 1:(8-128), preferably 1:(16-128), more preferably 1:(64-128), further more preferably 1:(60-70), even more preferably 1:64.

In the CD-MOF material, CD-MOF has a minimum building unit with a chemical formula of [(C₄₈H₈₀O₄₀)(KOH)₂]₆, 8112, where one CD-MOF molecular contains six γ-cyclodextrin molecules, that is, 1 mol of the CD-MOF material contains 6 mol of γ-cyclodextrin. According to the loading amount of nano-silver, the content of CD-MOF of the CD-MOF material in the composite 1 can be approximated as 95% to 96% of the composite 1.

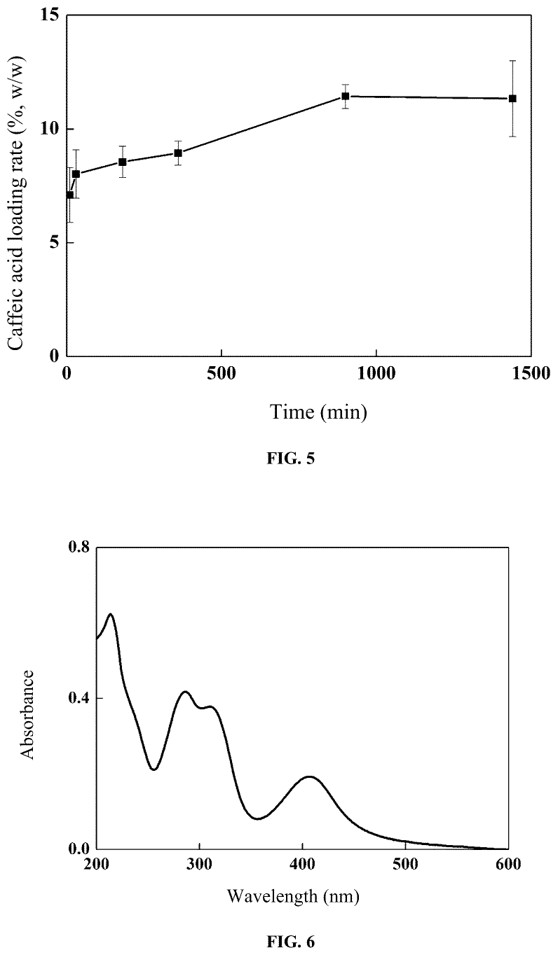

In some embodiments, in preparing the composite 2, experiments are conducted by utilization of the composite 1 prepared under optimal conditions, and with a molar ratio of γ-cyclodextrin in the composite 1 to caffeic acid of 1:64. The influence of different reaction time (10 min, 30 min, 180 min, 360 min, 900 min, 1440 min) on the caffeic acid loading rate is compared. The results are shown in FIG. 5. From FIG. 5, it can be seen that the incubation time of caffeic acid is 10 minutes to 1,500 minutes, preferably 180 minutes to 1,500 minutes, more preferably 800 minutes to 1,440 minutes, and even more preferably 850 minutes to 900 minutes.

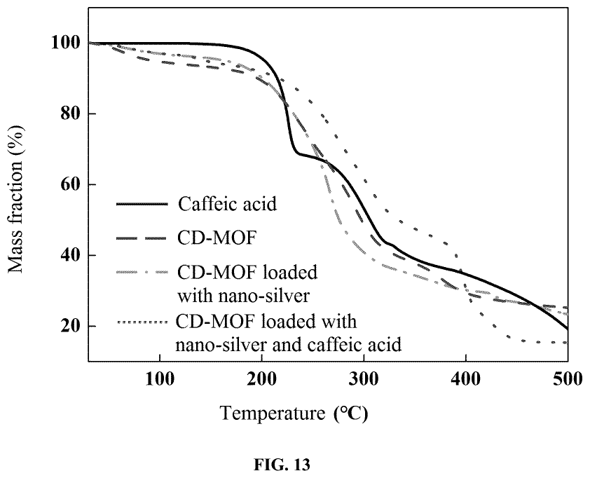

In the composite 2 prepared by the method of the present disclosure, a silver content (w/w) is ≥1%, preferably ≥2%, more preferably ≥4%; a caffeic acid content (w/w) is ≥2.5%, preferably ≥5%, more preferably ≥10%; a thermogravimetric loss of caffeic acid is 16% less than that of free caffeic acid at a caffeic acid decomposition temperature of 230° C. (FIG. 13, obtained by measuring the product of Example 1).

The following is illustrated with an example under optimal conditions:

### Example 1

(1) γ-cyclodextrin (648 mg, 0.5 mmol), potassium hydroxide (256 mg, 4.56 mmol), and ultrapure water (20 mL) were added to a beaker, stirred at room temperature and filtered with a 0.45 μm aqueous filter membrane to obtain a solution 1.
(2) After methanol (12 mL) was placed in an ultrasonic tube in advance, the solution 1 was placed in the ultrasonic tube to form a milky white solution 2. The ultrasonic tube was placed into a water bath at 60° C., and allowed to stand for 15 min to obtain a clear and transparent solution 3.
(3) The solution 3 was subjected to an ultrasonic treatment, and polyethylene glycol (8000) (256 mg) was added rapidly after the ultrasonic treatment was started, and a crude product was obtained after the reaction was completed.
(4) The crude product was transferred from the ultrasonic tube to the beaker, and allowed to stand for 1 h to collect a precipitate. The precipitate was washed three times with methanol by centrifugation, and after centrifugal separation, methanol was removed and a cleaned precipitate was collected.
(5) The cleaned precipitate was put into a vacuum drying oven, dried at 50° C. for 12 hours under vacuum conditions, and cooled to room temperature to obtain a CD-MOF material.
(6) 100 mg of the CD-MOF material was placed in 5 mL of an ethanol solution containing silver nitrate (a concentration of silver nitrate in the ethanol solution is 7.5 mM), and incubated at 37° C. and 180 rpm for 12 h by shaking in a shaker in the dark, to obtain an reactant.
(7) The reactant was centrifuged twice at 5,000 rpm, a supernatant was discarded, and a residual solvent was dried with a filter paper, and a solid could be collected. The solid was vacuum-dried at 50° C. for 5 h to obtain a CD-MOF loaded with nano-silver, called as composite 1.
(8) 50 mg of the composite 1 was added into 50 mL of an ethanol solution containing caffeic acid (a concentration of caffeic acid in the ethanol solution is 8 mg/mL) to form a mixture, where a molar ratio of γ-cyclodextrin in the composite 1 to caffeic acid is 1:64. The mixture was subjected to an incubation under magnetic stirring at 180 rpm and a room temperature for 15 hours in the dark, to obtain an incubated solution.
(9) The incubated solution was centrifuged at 5,000 rpm, a supernatant was discarded, and a residual solvent was dried with a filter paper, and a sediment could be collected. The sediment was vacuum-dried at 50° C. for 5 h to obtain a CD-MOF loaded with caffeic acid and nano-silver, called as composite 2.

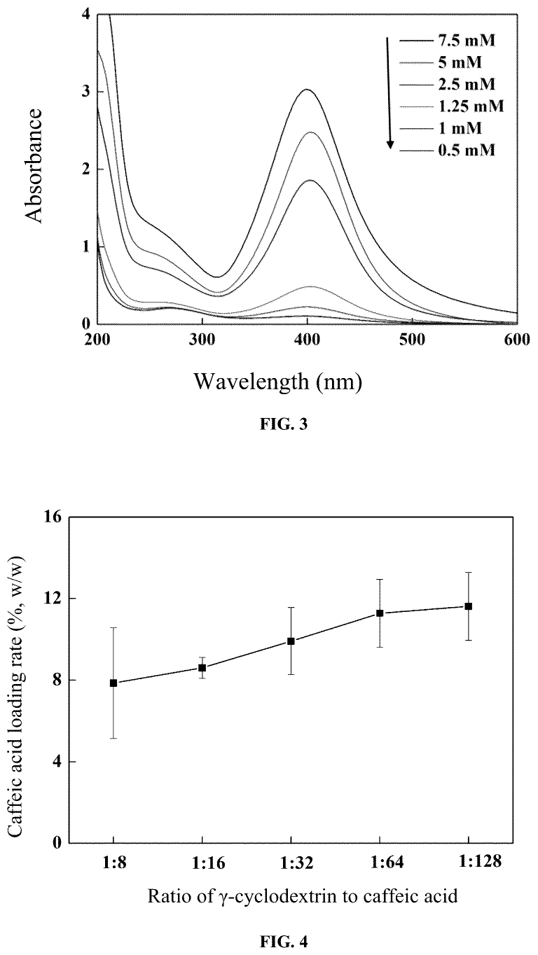

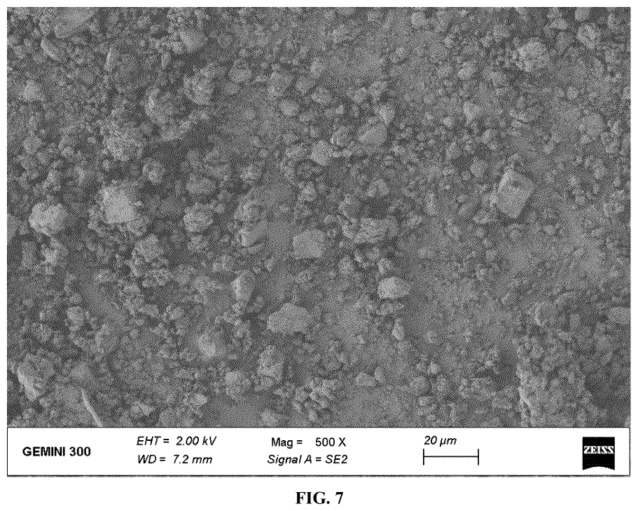

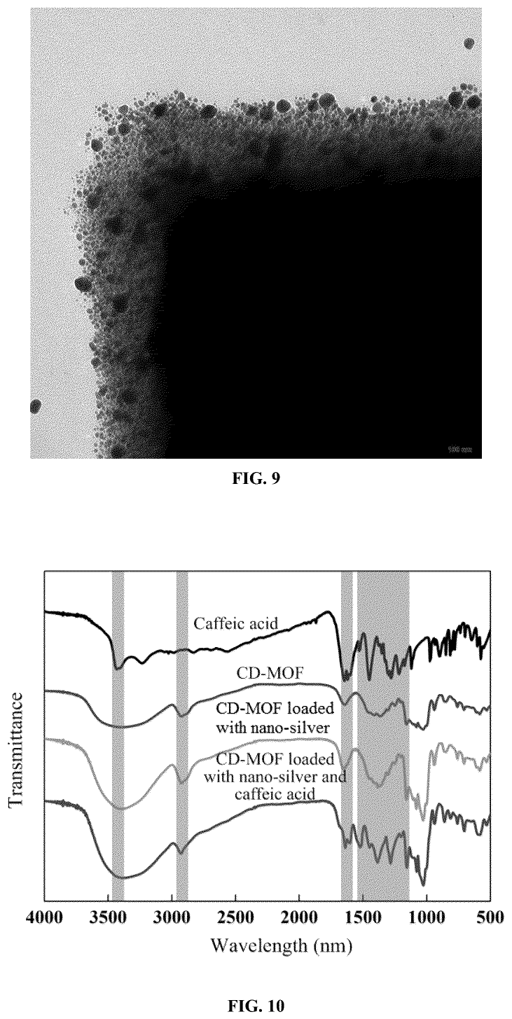

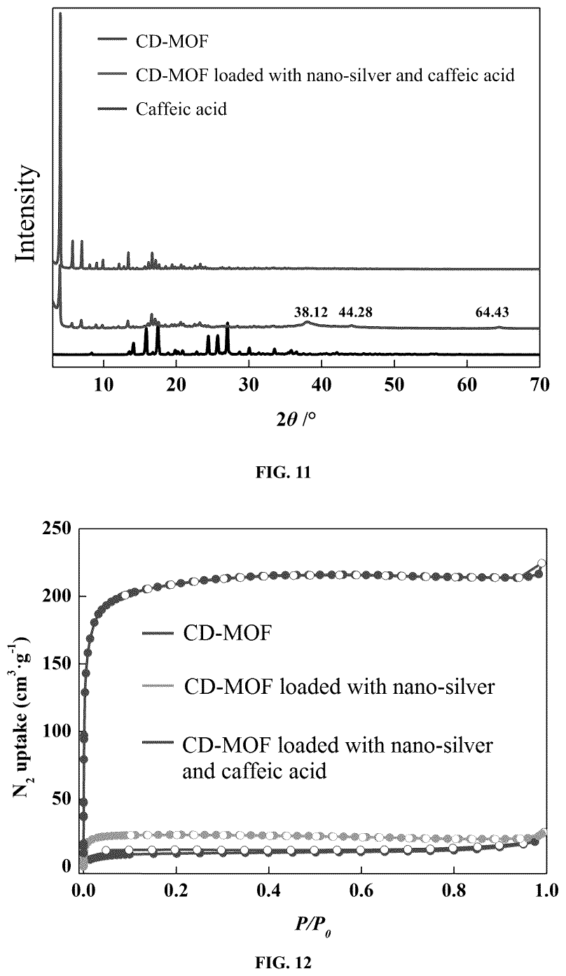

In the example, The UV spectrum of the composite 1 after being dissolved in water is shown in FIG. 3. From FIG. 3, it can be seen that there is an obvious characteristic peak of nano-silver at 400 nm⁻¹, indicating that nano-silver is successfully prepared, and an absorption peak that increased as the concentration of silver nitrate increased. The UV spectrum of the composite 2 after being dissolved in water is shown in FIG. 6. From FIG. 6, it can be seen that there are obvious characteristic peaks of caffeic acid at 217 nm, 290 nm, and 320 nm, and obvious characteristic peaks of nano-silver at 400 nm, indicating that caffeic acid and nano-silver are successfully loaded on the CD-MOF. The powder X-ray diffraction pattern of the composite 2 is shown in FIG. 11. From FIG. 11, it can be seen that the peak positions in XRD pattern of the composite 2 coincided with that of the CD-MOF, which indicates that the structure of the CD-MOF is not destroyed after loading with caffeic acid and nano-silver simultaneously. At 38.12°, 44.28°, and 64.43°, three new characteristic peaks of nano-silver appeared, indicating the successful loading of nano-silver. Compared with the XRD pattern of caffeic acid, the characteristic peak of caffeic acid disappeared, indicating that caffeic acid is in the cavity of the CD-MOF. The infrared spectra of the composite 1 and the composite 2 are shown in FIG. 10. From FIG. 10, it can be seen that the peak positions of the composite 1 and the composite 2 coincided with that of the CD-MOF, showing that the structure of the CD-MOF is not destroyed after loading with nano-silver and caffeic acid. Compared with the infrared spectrum of caffeic acid, the characteristic peak in the infrared spectrum of caffeic acid of the composite 2 is weaker or even partially disappeared, indicating that caffeic acid is in the cavity of the CD-MOF. In this example, a product of the target structure is obtained.

The nitrogen uptake diagrams of the composite 1 and the composite 2 are shown in FIG. 12. By BET calculation, compared with a specific surface area of the CD-MOF of 836.40 m²·g⁻¹, the specific surface areas of the composite 1 and the composite 2 are reduced to 79.06 m²·g⁻¹ and 32.75 m²·g⁻¹, respectively, showing that caffeic acid and nano-silver are loaded in the cavity of the CD-MOF, thereby reducing the internal porosity of the CD-MOF. In the example, a product of the target structure is obtained.

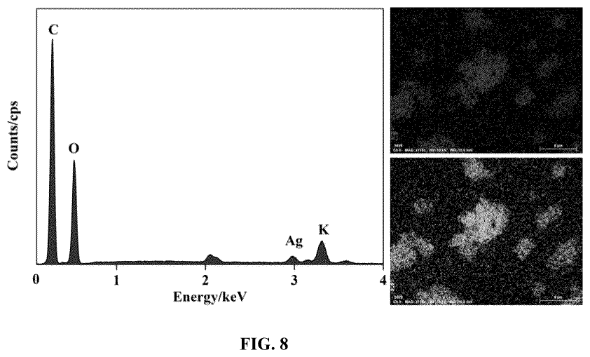

The SEM image of the composite 2 synthesized in the example is shown in FIG. 7. From FIG. 7, it can be seen that the composite 2 still has a certain regular geometric appearance. The energy spectrum of the composite 2 is shown in FIG. 8. From FIG. 8, it can be seen that the distribution of silver element representing nano-silver is consistent with that of potassium element representing the CD-MOF, proving that nano-silver is loaded on the CD-MOF. The TEM image of the composite 2 is shown in FIG. 9. From FIG. 9, it can be seen that nano-silver particles can be clearly seen on the CD-MOF, and nano-silver particles are uniform in size and stable in shape.

The MIC and MBC results of the CD-MOF, caffeic acid (CA), CD-MOF loaded with caffeic acid (CA@CD-MOF), CD-MOF loaded with nano-silver (Ag@CD-MOF), and CD-MOF loaded with caffeic acid and nano-silver (CA@Ag@CD-MOF) are shown in Table 1:

TABLE 1

| | S. aureus | |
|---|---|---|
| | MIC | MBC |
| Sample | (mg · mL⁻¹) | (mg · mL⁻¹) |
| CD-MOF | >200 | >200 |
| CA | 4 | 4 |
| CA@CD-MOF | 25 | >25 |
| Ag@CD-MOF | 0.5 | 0.5 |
| CA@Ag@CD-MOF | 0.25 | 0.5 |

From Table 1, it can be seen that in the composite of the present disclosure, nano-silver and caffeic acid have a synergistic antibacterial effect, especially for S. aureus, which is better than that of the CD-MOF loaded with nano-silver or caffeic acid alone.

Only several implementations of the present disclosure are described in detail in the above embodiments, and they should not be construed as limitations to the scope of the present disclosure. It should be noted that those skilled in the art could further make variations and improvements without departing from the conception of the present disclosure. These variations and improvements all fall within the protection scope of the present disclosure. Therefore, the protection scope of the present disclosure should be subject to the protection scope defined by the claims.

1. A metal-organic framework composite, comprising a cyclodextrin metal-organic framework (CD-MOF) material, and nano-silver and caffeic acid that are loaded in the CD-MOF material; wherein the CD-MOF material is prepared from γ-cyclodextrin; nano-silver is loaded at a mass content of 4% to 5% of a total mass of the composite; and caffeic acid is loaded at a mass content of 11% to 12% of the total mass of the composite.

2. The metal-organic framework composite of claim 1, wherein nano-silver is fixed in a large cavity inside the CD-MOF material, and caffeic acid is filled in remaining cavities of the CD-MOF material.

3. The metal-organic framework composite of claim 1, wherein in the CD-MOF material, potassium ions are in an 8-coordination form, such that the potassium ions combine with six γ-cyclodextrin molecules to form a minimum building unit of the CD-MOF material, in which two potassium ions are paired with one γ-cyclodextrin molecule; and the metal-organic framework composite has a chemical formula of [(C48H80O40)(KOH)2]n.

4. A method for preparing a metal-organic framework composite, comprising:
(1) placing a CD-MOF material prepared from γ-cyclodextrin in an ethanol solution containing silver nitrate to obtain a first mixture, and subjecting the first mixture to a dynamic contact reaction in the dark to obtain a CD-MOF loaded with nano-silver; and
(2) placing the CD-MOF loaded with nano-silver in an ethanol solution containing caffeic acid to obtain a second mixture, and subjecting the second mixture to an incubation in the dark to obtain a CD-MOF loaded with caffeic acid and nano-silver.

5. The method of claim 4, wherein the dynamic contact reaction is performed by an oscillation treatment.

6. The method of claim 4, wherein in step (1), the ethanol solution containing silver nitrate has a concentration of silver nitrate of 0.5 mM to 10 mM; and a ratio of the mass of the CD-MOF material to the molar of silver nitrate is in the range of 100 mg:(0.0025-0.05) mmol.

7. The method of claim 4, wherein in step (1), the dynamic contact reaction is conducted for 1 hour to 18 hours.

8. The method of claim 4, wherein in step (2), a molar ratio of γ-cyclodextrin in the CD-MOF loaded with nano-silver to caffeic acid is in the range of 1:(25-70).

9. The method of claim 4, wherein in step (2), the incubation is conducted for 500 minutes to 1,000 minutes.

10. The method of claim 4, wherein the incubation is conducted at a temperature of 35° C. to 45° C.

11. The method of claim 4, wherein the CD-MOF material is prepared by a process comprising:
subjecting an aqueous solution containing γ-cyclodextrin and potassium hydroxide to a first ultrasonic mixing to obtain a mixed solution;
subjecting the mixed solution to a reaction in a water bath to obtain a reaction solution;
subjecting the reaction solution to a second ultrasonic mixing while adding polyethylene glycol into the reaction solution to obtain a crude product; and
subjecting the crude product to a washing and a drying, to obtain the CD-MOF material; wherein
in the aqueous solution containing γ-cyclodextrin and potassium hydroxide, a molar ratio of γ-cyclodextrin to potassium hydroxide is in the range of 1:(5-10);
polyethylene glycol has a molecular weight of 8,000, and a molar ratio of polyethylene glycol to γ-cyclodextrin is in the range of (0.06-0.07):1; and
the reaction in the water bath is conducted at a temperature of 55° C. to 65° C.

12. The method of claim 4, wherein the method further comprises a post-treatment after the dynamic contact reaction and the incubation in step (1) and step (2), and the post-treatment is performed by subjecting reactant of the dynamic contact reaction and reactant of the incubation to a centrifugation respectively, discarding a supernatant, and conducting a vacuum drying on a remaining product of centrifugation.

13. A metal-organic framework composite prepared by the method of claim 4.

14.-15. (canceled)

16. The method of claim 9, wherein the incubation is conducted at a temperature of 35° C. to 45° C.

17. The metal-organic framework composite of claim 13, wherein the dynamic contact reaction is performed by an oscillation treatment.

18. The metal-organic framework composite of claim 13, wherein in step (1), the ethanol solution containing silver nitrate has a concentration of silver nitrate of 0.5 mM to 10 mM; and a ratio of the mass of the CD-MOF material to the molar of silver nitrate is in the range of 100 mg:(0.0025-0.05) mmol.

19. The metal-organic framework composite of claim 13, wherein in step (1), the dynamic contact reaction is conducted for 1 hour to 18 hours.

20. The metal-organic framework composite of claim 13, wherein in step (2), a molar ratio of γ-cyclodextrin in the CD-MOF loaded with nano-silver to caffeic acid is in the range of 1:(25-70).
